(19) United States
(12) Patent Application Publication
(10) Pub. No.: US 2025/0086480 A1
(43) Pub. Date: Mar. 13, 2025

(54) METHOD FOR TASK EXECUTION BASED ON KNOWLEDGE GRAPH OBTAINED THROUGH ENTITY ALIGNMENT

(71) Applicant: ZHEJIANG LAB, Hangzhou (CN)

(72) Inventors: Xiongnan JIN, Hangzhou (CN); Yongheng WANG, Hangzhou (CN); Manni DUAN, Hangzhou (CN); Jiawei WANG, Hangzhou (CN); Yan SHAO, Hangzhou (CN); Kun LI, Hangzhou (CN); Yafei LU, Hangzhou (CN); Xiaoran YAN, Hangzhou (CN)

(21) Appl. No.: 18/580,105

(22) PCT Filed: Sep. 14, 2023
(86) PCT No.: PCT/CN2023/118901

§ 371 Date: Jan. 17, 2024

(30) Foreign Application Priority Data
Sep. 1, 2023 (CN) 202311126132.4

(51) Int. Cl. G06N 5/022; G06N 7/01

(52) U.S. Cl. CPC G06N 5/022; G06N 7/01

(57) ABSTRACT

Methods, devices, and computer-readable media of task execution based on a knowledge graph obtained by entity alignment are provided. In one aspect, a method includes: obtaining a knowledge graph pair including a first knowledge graph and a second knowledge graph, selecting a target entity by filtering entities in the first knowledge graph, determining a centrality and an uncertainty of the target entity based on the target entity, an entity corresponding to a neighboring node, and entities in the second knowledge graph, constructing a sample entity pair based on the centrality and the uncertainty of the target entity, training a to-be-trained entity alignment model using the sample entity pair, performing entity alignment on to-be-aligned knowledge graphs according to the trained entity alignment model to obtain a merged knowledge graph, and executing a target task based on the merged knowledge graph.

### TECHNICAL FIELD

The present disclosure relates to the technical field of knowledge graph construction, in particular to a method for task execution based on a knowledge graph obtained through entity alignment.

### BACKGROUND

In construction of a knowledge graph, entity alignment can effectively solve the heterogeneity problem when multiple knowledge graphs are interoperable, enabling heterogeneous knowledge graphs to enhance their coverage.

Usually, in an entity alignment method, entities in the knowledge graph are mainly selected and annotated manually, and then the annotated entities are used for a training process of an entity alignment model. This method is time-consuming and labour-intensive, and the annotated entities obtained often fail to achieve good training results on an untrained entity alignment model. The alignment accuracy of the entity alignment model trained by this method is generally not high. Therefore, it is particularly important to select entities with a high training value for training an entity alignment model, in order to obtain an entity alignment model with high accuracy.

### SUMMARY

The present disclosure provides a method for task execution based on a knowledge graph obtained through entity alignment, to partially solve the aforementioned problems existing in the prior art.

The present disclosure adopts following technical solutions.

The present disclosure provides a method for task execution based on a knowledge graph obtained through entity alignment, including:
obtaining a knowledge graph pair, which includes a first knowledge graph and a second knowledge graph;
selecting a target entity from entities in the first knowledge graph;
determining a centrality of the target entity based on an entity corresponding to a neighboring node of a node corresponding to the target entity in the first knowledge graph within a preset adjacency range;
determining an uncertainty of the target entity based on alignment probabilities between at least some entities in the second knowledge graph and the target entity, and alignment probabilities between the entity corresponding to the neighboring node and at least some entities in the second knowledge graph;
constructing a sample entity pair based on the centrality and the uncertainty of the target entity;
training a to-be-trained entity alignment model based on the sample entity pair;
performing entity alignment on to-be-aligned knowledge graphs according to a trained entity alignment model, to obtain a merged knowledge graph after the entity alignment; and executing a target task based on the merged knowledge graph.

In some embodiments, selecting the target entity from the entities in the first knowledge graph includes:
determining an out-degree of each of the entities in the first knowledge graph based on connection relationships between the entities in the first knowledge graph;
filtering the entities in the first knowledge graph based on the out-degree of each of the entities in the first knowledge graph, to obtain the target entity.

In some embodiments, determining the centrality of the target entity based on the entity corresponding to the neighboring node of the node corresponding to the target entity in the first knowledge graph within the preset adjacency range includes:
determining a single centrality of the target entity based on an out-degree of the target entity;
determining a single centrality of the entity corresponding to the neighboring node based on an out-degree of the entity corresponding to the neighboring node of the node corresponding to the target entity in the first knowledge graph within the preset adjacency range; and
determining the centrality of the target entity based on the single centrality of the target entity and the single centrality of the entity corresponding to the neighboring node.

In some embodiments, determining the uncertainty of the target entity based on the alignment probabilities between the at least some entities in the second knowledge graph and the target entity, and the alignment probabilities between the entity corresponding to the neighboring node and the at least some entities in the second knowledge graph includes:
determining the alignment probabilities between the target entity and the at least some entities in the second knowledge graph;
determining a single uncertainty of the target entity based on the alignment probabilities between the target entity and the at least some entities in the second knowledge graph;
determining the alignment probabilities between the entity corresponding to the neighboring node and the at least some entities in the second knowledge graph based on the entity corresponding to the neighboring node and the at least some entities in the second knowledge graph;
determining a single uncertainty of the entity corresponding to the neighboring node based on the alignment probabilities between the entity corresponding to the neighboring node and the at least some entities in the second knowledge graph; and
determining the uncertainty of the target entity based on the single uncertainty of the target entity and the single uncertainty of the entity corresponding to the neighboring node.

In some embodiments, determining the single uncertainty of the target entity based on the alignment probabilities between the target entity and the at least some entities in the second knowledge graph includes:
determining a difference between the alignment probabilities between the target entity and the at least some entities in the second knowledge graph based on the alignment probabilities between the target entity and the at least some entities in the second knowledge graph;
determining the single uncertainty of the target entity based on the difference between the alignment probabilities between the target entity and the at least some entities in the second knowledge graph;
determining the single uncertainty of the entity corresponding to the neighboring node based on the alignment probabilities between the entity corresponding to the neighboring node and the at least some entities in the second knowledge graph includes:
determining a difference between the alignment probabilities between the entity corresponding to the neighboring node and the at least some entities in the second knowledge graph based on the alignment probabilities between the entity corresponding to the neighboring node and the at least some entities in the second knowledge graph; and
determining the single uncertainty of the entity corresponding to the neighboring node based on the difference between the alignment probabilities between the entity corresponding to the neighboring node and the at least some entities in the second knowledge graph.

In some embodiments, constructing the sample entity pair based on the centrality and the uncertainty of the target entity includes:
determining a centrality weight for the centrality of the target entity, and an uncertainty weight for the uncertainty of the target entity;
determining a representative value of the target entity based on the centrality of the target entity, the centrality weight, the uncertainty of the target entity, and the uncertainty weight; and
filtering the target entity based on the representative value of the target entity; and constructing the sample entity pair based on a filtered target entity.

In some embodiments, determining the centrality weight for the centrality of the target entity, and the uncertainty weight for the uncertainty of the target entity includes:
determining the centrality weight for the centrality of the target entity, and the uncertainty weight for the uncertainty of the target entity based on a difference between the centrality and the uncertainty of the target entity.

In some embodiments, determining the centrality weight for the centrality of the target entity, and the uncertainty weight for the uncertainty of the target entity includes:
determining the centrality weight for the centrality of the target entity, and the uncertainty weight for the uncertainty of the target entity based on a number of a current training round of an entity alignment model, where the larger the number of the current training round, the smaller the centrality weight for the centrality of the target entity, and the greater the uncertainty weight for the uncertainty of the target entity.

The present disclosure provides a computer-readable storage medium, where the storage medium stores a computer program, and the computer program when executed by a processor achieves the above method of task execution based on the knowledge graph obtained by entity alignment.

The present disclosure provides an electronic device including a memory, a processor and a computer program stored on the memory and runnable on the processor, where the processor, when the program is executed by the processor, achieves the above method of task execution based on the knowledge graph obtained by entity alignment.

At least one of the above technical solutions adopted in the present application can achieve the following beneficial effects.

From the above method, it can be seen that in the method of task execution based on the knowledge graph obtained by entity alignment provided in the present disclosure, knowledge graph pairs including the first knowledge graph and the second knowledge graph are obtained. By filtering the entities in the first knowledge graph, each target entity is selected. Based on the entity corresponding to the neighboring node of each target entity and each target entity, and the alignment probabilities between each target entity and the entities in the second knowledge graph, the centrality and uncertainty of each target entity are determined. Then, based on the centrality and uncertainty of each target entity, each sample entity pair is constructed, and the to-be-trained entity alignment model is trained using each sample entity pair. Finally, the trained entity alignment model is used to align the entities in each knowledge graph, and the merged knowledge graph after entity alignment is used to execute the target task.

From the above content, it can be seen that the method for task execution based on the knowledge graph obtained through entity alignment provided in the present disclosure can evaluate the target entities with a high training value in the training process of an entity alignment model based on the centrality and uncertainty of the target entity in the knowledge graph, and thus the target entity with a high training benefit is used in the training process of an entity alignment model, to obtain an entity alignment model with high alignment accuracy, to execute the target task. The method can not only obtain an entity alignment model with high alignment accuracy, but also greatly reduce the sample annotation cost during the training process, which improves the efficiency of the model training process, and also significantly improves the efficiency of the overall task execution.

### BRIEF DESCRIPTION OF DRAWINGS

The accompanying drawings illustrated herein are used to provide further understanding of the present disclosure and form a part of the present disclosure. The exemplary embodiments and descriptions of the present disclosure are used to explain the present disclosure, and do not constitute an improper limitation of the present disclosure.

FIG. 1 is a flowchart of a method for task execution based on a knowledge graph obtained through entity alignment provided in the present disclosure.

FIG. 2 is a schematic diagram of a knowledge graph provided in the present disclosure.

FIG. 3 is a schematic diagram of merging knowledge graphs through entity alignment provided in the present disclosure.

FIG. 4 is a schematic diagram of an apparatus for task execution based on a knowledge graph obtained through entity alignment provided in the present disclosure.

FIG. 5 is a schematic diagram of a structure of an electronic device corresponding to FIG. 1 provided in the present disclosure.

### DETAILED DESCRIPTION

In order present the purposes, technical solutions and advantages of the present disclosure clearer, the technical solutions of the present disclosure will be clearly and completely described below in conjunction with specific embodiments and corresponding drawings of the present disclosure. The described embodiments are only a part of the embodiments of the present disclosure, and not all of them. Other embodiments achieved by those skilled in the art based on the embodiments in the present disclosure without paying creative work shall all fall within the scope of protection of the present disclosure.

The technical solutions provided in the embodiments of the present disclosure are described in detail below in conjunction with the accompanying drawings.

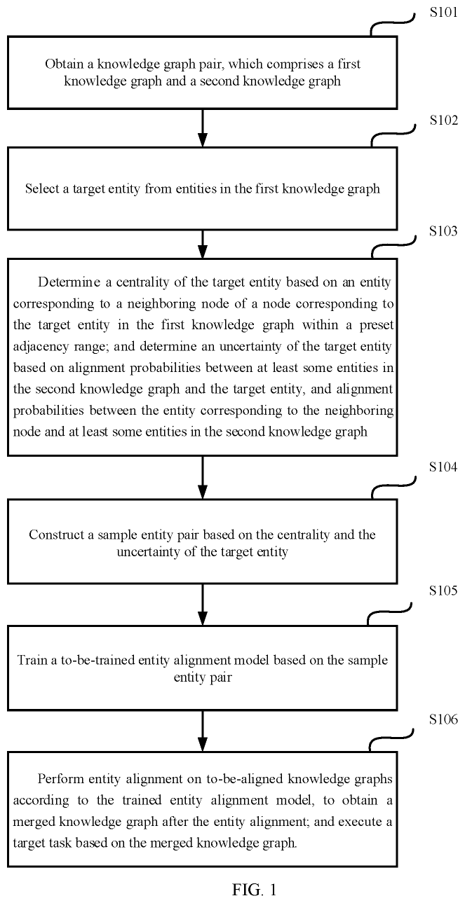

FIG. 1 is a flowchart of a method for task execution based on a knowledge graph obtained through entity alignment provided in the present disclosure. The method includes the following steps S101-S106.

In S101, a knowledge graph pair is obtained, which includes a first knowledge graph and a second knowledge graph.

In the process of constructing a knowledge graph, entity alignment can be used to merge heterogeneous knowledge graphs, to improve the coverage of knowledge graphs, and entity alignment models can be trained and iterated through model training to effectively improve entity alignment efficiency. Therefore, how to select entities with high training benefits for the training process of the entity alignment model, and then obtain an entity alignment model with high alignment accuracy, is particularly important.

The execution subject of the method for task execution based on the knowledge graph obtained through entity alignment provided in the present disclosure can be a terminal device such as a desktop, a laptop, or a server. In addition, the execution subject in the present disclosure can also be in the form of software, such as a client installed in a terminal device or an online platform that can be logged in online. For the convenience of explanation, in the present disclosure, the terminal device is taken as the executing subject to explain the method for task execution.

Based on this, the terminal device applying the method of task execution based on the knowledge graph obtained through entity alignment provided in the present disclosure can merge knowledge graphs through an entity alignment model, and use the merged knowledge graph to execute target tasks. The target tasks executed by the terminal device can be according to actual scenarios, such as in information recommendation scenarios, when recommending information related to tourist attractions to users, a knowledge graph containing tourist attraction information and a knowledge graph containing local cuisine information can be merged into a knowledge graph containing tourist attraction information and local cuisine information, and the knowledge graph containing tourist attraction information and local cuisine information is pushed to users, which allows users to simultaneously get and choose information of tourist attractions and local cuisine when viewing tourist attraction related information. For example, in risk control scenarios, the security of risk control through a single risk type is usually low. The terminal device can merge multiple knowledge graphs each of which contains a single risk type and use the merged knowledge graph with multiple risk types to perform risk control tasks, to improve the efficiency and security of the overall risk control task.

In the present disclosure, the terminal device can obtain a knowledge graph pair including a first knowledge graph and a second knowledge graph. The terminal device can obtain knowledge graph pairs with known entity alignment results, and select the first knowledge graph and the second knowledge graph in each of the knowledge graph pairs.

It should be noted that the selection of the first and second knowledge graphs mentioned above is not strict, but rather relative. For example, for knowledge graph A and knowledge graph B in a certain knowledge graph pair, if the target entity is selected in knowledge graph A, knowledge graph A is selected as the first knowledge graph, and knowledge graph B is selected as the second knowledge graph. Conversely, if the target entity is selected in knowledge graph B, knowledge graph B is selected as the first knowledge graph, and knowledge graph A is selected as the second knowledge graph.

In S102, a target entity is selected from entities in the first knowledge graph.

In the present disclosure, the terminal device can select each target entity from the entities in the first knowledge graph of the knowledge graph pair.

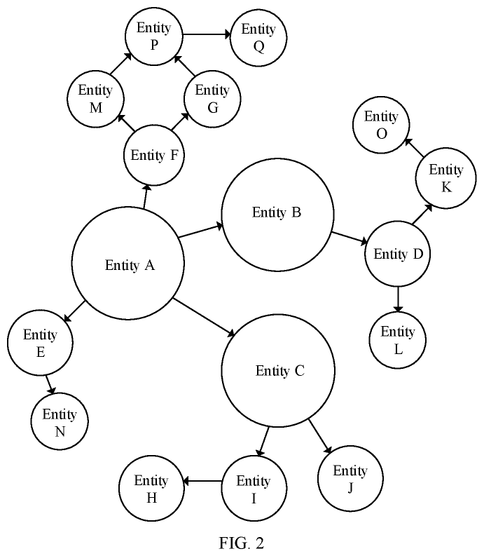

The terminal device can determine a core entity in the first knowledge graph based on the number of first-order adjacent entities of each entity in the first knowledge graph, and whether the order of the farthest adjacent entity of a first order adjacent entity meets a preset value. The core entity is determined as the target entity. In some embodiments, for each entity in the first knowledge graph, when the number of the first-order adjacent entities of the entity is greater than or equal to the preset value, the terminal device determines the order of the farthest adjacent entity of each of the first-order adjacent entities, if there is one or more first-order adjacent entities, and the orders of farthest adjacent entities of the one or more first-order adjacent entities are greater than or equal to the preset value, the entity can be determined as the core entity and the core entity can be used as the target entity. In order to illustrate how to determine the core entity in the knowledge graph, a schematic diagram of the knowledge graph is introduced below, as shown in FIG. 2.

FIG. 2 is a schematic diagram of a knowledge graph provided in the present disclosure.

In the knowledge graph shown in FIG. 2, entity B, entity C, entity F, and entity E are all first-order adjacent entities of entity A, that is, the number of first-order adjacent entities of entity A is 4. Entity O is the third-order adjacent entity of entity B, and is the farthest adjacency entity of entity B. Therefore, when the preset value for the number of first order adjacent entities is 4 and the preset value for the order of the farthest adjacent entity of the first order adjacent entity is 3, the core entity of the knowledge graph shown in FIG. 2 is entity A, and entity A is used as the target entity when the knowledge graph is used as the first knowledge graph.

It should be noted that in practical applications, the aforementioned preset values can be determined according to actual needs. The preset values in the example in FIG. 2 are listed for ease of understanding, and the present disclosure does not limit the specific values of the preset values.

In addition to the above manner, the terminal device can also determine each core entity based on the out-degree of each of the entities, to determine each target entity.

The terminal device can remove an entity with an out-degree of 1 from the first knowledge graph, and after removal, an entity with an out-degree of 1 may be generated in the first knowledge graph again, and the entity with the out-degree of 1 is removed again. This process is repeated to peel off the entities of the first knowledge graph layer by layer until an entity with an out-degree of 1 no longer appears in the first knowledge graph, and then the core entity of the first knowledge graph is determined.

Continuing with the above example, in the knowledge graph shown in FIG. 2, entities K, P, and I are entities with out-degree of 1. After these entities with out-degree of 1 are sequentially removed, entities E, M, and D will become entities with out-degree of 1. In this way, the entities with out-degree of 1 will be removed layer by layer. Ultimately, only entity A remains in the knowledge graph shown in FIG. 2. Therefore, entity A is the core entity of the knowledge graph shown in FIG. 2, and the terminal device can further use entity A as the target entity when the knowledge graph is the first knowledge graph.

In S103, a centrality for the target entity is determined based on the entity corresponding to the neighboring node of the target entity in the first knowledge graph in the preset adjacency range, and an uncertainty of the target entity is determined based on alignment probabilities between at least some entities in the second knowledge graph and the target entity, and alignment probabilities between the entity corresponding to the neighboring node and at least some entities in the second knowledge graph.

In the present disclosure, the terminal device needs to determine the centrality and uncertainty of each target entity in order to select a target entity that has high training benefits for the entity alignment model training process. The centrality of the target entity can be used to reflect whether it is a centre entity in an entity alignment process of the knowledge graph to which the target entity belongs. For example, using a high centrality target entity in the training process can effectively compare the training result of the entity alignment model training process with the standard result, which improves the model training efficiency. The uncertainty of the target entity can be used to reflect the alignment difficulty of the knowledge graph to which the target entity belongs during the entity alignment process. For example, using a high uncertainty target entity in the training process can effectively train and improve the entity alignment ability of the entity alignment model, thereby improving the alignment accuracy of the entity alignment model.

It should be noted that the present disclosure takes into account the impact of a neighboring entity of the target entity on the target entity. Therefore, the centrality and uncertainty of the target entity are jointly determined by the target entity itself and the neighboring entity of the target entity. The centrality of the target entity can be reflected by determining the centrality of the target entity, and the uncertainty of the target entity can be reflected by determining the uncertainty of the target entity.

For each target entity, the terminal device determines the centrality of the target entity based on the entity corresponding to the neighboring node of the node corresponding to the target entity in the preset adjacency range. The terminal device can determine the single centrality of the target entity based on the out-degree of the target entity (for example, the out-degree of the target entity may be determined as the single centrality of the target entity), and determine the single centrality of the entity corresponding to the neighboring node of the node corresponding to the target entity based on the out-degree of the entity corresponding to the neighboring node, and then, based on the single centrality of the target entity and the single centrality of the entity corresponding to the neighboring node of the node corresponding to the target entity, determine the centrality of the target entity. Refer to the following formula:

$${R}_{n} ( {e}_{i} ) = {k}_{s} ( {e}_{i} ) + p {\sum }_{{e}_{j} ∈ {N}_{{e}_{i}} ( 1 )} {k}_{s} ( {e}_{j} ) + {p}^{2} {\sum }_{{e}_{j} ∈ {N}_{{e}_{i}} ( 2 )} {k}_{s} ( {e}_{j} ) + … + {p}^{n} {\sum }_{{e}_{j} ∈ {N}_{{e}_{i}} ( n )} {k}_{s} ( {e}_{j} )$$

eᵢ represents the i-th target entity, Rₙ(eᵢ) represents the centrality of the i-th target entity, kₛ(eᵢ) represents the single centrality of the i-th target entity, kₛ(eᵢ) represents the single centrality of the j-th entity corresponding to the neighboring node of the node corresponding to the target entity within the preset adjacency range, p represents a preset constant coefficient in an interval of [0,1], and Nₑ_{ᵢ}(n) represents the n-th order adjacent entity of the i-th target entity.

From the above formula, it can be seen that the larger the adjacency order n of the target entity eᵢ, the smaller the impact of the entity of the neighboring node on the centrality of the target entity. The present disclosure considers that when the number of the adjacency order n is too large, it will cause noise interference in the determination process of the centrality of the target entity. Therefore, the number of the adjacency order n is generally preset to be 3. Of course, the adjacency order n can also be dynamically adjusted according to the actual situation.

In the present disclosure, for each target entity, the terminal device may determine the uncertainty of the target entity based on the alignment probabilities between the target entity and at least some entities in the second knowledge graph of the knowledge graph pair, and the alignment probabilities between the entity corresponding to the neighboring node of the target entity and at least some entities in the second knowledge graph.

The terminal device can determine the difference between the alignment probabilities between the target entity and at least some entities in the second knowledge graph by the alignment probabilities between the target entity and at least some entities in the second knowledge graph, and determine the difference between the alignment probabilities between the entity corresponding to the neighboring node of the target entity and at least some of the entities in the second knowledge graph by the alignment probabilities between the entity corresponding to the neighboring node of the target entity and at least some entities in the second knowledge graph. Refer to the following formula:

$$bt ( {e}_{i} ) = P ( {y}_{i} = {e}_{m 1}^{*} \vert {e}_{i} ) - P ( {y}_{i} = {e}_{m 2}^{*} \vert {e}_{i} )$$

bt(eᵢ) represents the difference between the alignment probabilities between the i-th target entity and at least some entities in the second knowledge graph, and can also represents the uncertainty of the i-th target entity. P(yᵢ=e*ₘ|eᵢ) represents the alignment probabilities between the i-th target entity and the entity e*ₘ in the second knowledge graph.

It should be noted that the value of bt(eᵢ) is negatively correlated with the single uncertainty of the target entity. The smaller the value of bt(eᵢ), the greater the single uncertainty of the target entity, indicating that there may be multiple entity that can be aligned with the target entity in at least some entities in the second knowledge graph. The single uncertainty of the entity corresponding to the neighboring node of the target entity can also be determined through the above formula.

In some embodiments, when determining the difference between the alignment probabilities between the target entity and at least some entities in the second knowledge graph, two entities in the second knowledge graph with the highest alignment probabilities with the target entity can be selected for calculation. That is, the difference between a first alignment probability and a second alignment probability can be determined, where the first alignment probability is an alignment probability between the entity with the highest alignment probability with the target entity in the second knowledge graph and the target entity, and the second alignment probability is an alignment probability between the entity with the second highest alignment probability with the target entity in the second knowledge graph and the target entity. The smaller the difference between the first alignment probability and the second alignment probability, the greater the single uncertainty of the target entity. The single uncertainty of the entity corresponding to the neighboring node of the target entity can also be determined similarly.

Furthermore, the terminal device can determine the uncertainty of the target entity by the single uncertainty of the target entity and the single uncertainty of the entity corresponding to the neighboring node of the target entity. Refer to the following formula:

$${I}_{n} ( {e}_{i} ) = bt ( {e}_{i} ) + p {\sum }_{{e}_{j} ∈ {N}_{{e}_{i}} ( 1 )} bt ( {e}_{j} ) + {p}^{2} {\sum }_{{e}_{j} ∈ {N}_{{e}_{i}} ( 2 )} bt ( {e}_{j} ) + … + {p}^{n} {\sum }_{{e}_{j} ∈ {N}_{{e}_{i}} ( n )} bt ( {e}_{j} )$$

eᵢ represents the i-th target entity, Iₙ(eᵢ) represents the uncertainty of the i-th target entity, bt(eᵢ) represents the single uncertainty of the i-th target entity, bt(eⱼ) represents the single uncertainty of the j-th entity corresponding to the neighboring node of the target entity, p represents a preset constant coefficient in an interval of [0,1], and Nₑ_{ᵢ}(n) represents the n-th order adjacent entity of the i-th target entity.

From the above formula, it can be seen that the greater the adjacency order n of the target entity eᵢ, the smaller the impact of the single uncertainty of the entity of neighboring node on the uncertainty of the target entity. For the same reason for the formula used to determine the centrality of the target entity mentioned above, the present disclosure considers that when the number of the adjacency order n is too large, it will cause noise interference in the determination process of the uncertainty of the target entity. Therefore, the number of the adjacency order n is generally preset to be 3. Of course, the adjacency order n can also be dynamically adjusted according to the actual situation.

In S104, a sample entity pair is constructed based on the centrality and the uncertainty of each target entity.

In the present disclosure, the terminal device will determine the representative value of each target entity based on the centrality and uncertainty of the target entity, and select target entities used to construct a sample entity pair from these target entities based on the representative value.

After the target entity for constructing a sample entity pair is determined from the first knowledge graph, an entity in the second knowledge graph corresponding to the target entity can be determined based on correspondence relationships between the entities in the first knowledge graph and the entities in the second knowledge graph, to determine the sample entity pair.

The terminal device can select target entities each with a larger representative value as much as possible to construct each sample entity pair. A larger representative value means that the centrality of the target entity is good, which facilitates entity alignment, and the uncertainty of the target entity is high, which can improve the alignment ability of the entity alignment model. In some embodiments, the terminal device can add the centrality and the uncertainty of the target entity to determine the representative value of the target entity.

In some embodiments, when determining the representative value mentioned above, the terminal device can further introduce a centrality weight for the centrality and an uncertainty weight for the uncertainty, to determine the representative value of the target entity through the centrality, centrality weight, uncertainty, and uncertainty weight of the target entity.

The centrality weight and the uncertainty weight are mainly used to measure the contribution of the centrality and the uncertainty when determining the representative value of the target entity. The determination of the centrality weight and the uncertainty weight is closely related to the centrality and the uncertainty. The determination can be as follows: for any target entity, the terminal device can determine the centrality weight for the centrality of the target entity and the uncertainty weight for the uncertainty of the target entity based on a difference between the centrality and the uncertainty of the target entity. Refer to the following formula:

$$dif ( s ) = {f}_{R} ( s ) - {f}_{I} ( s ) \\ α = \{ \begin{matrix}1 , & dif ( s ) > θ \\ p , & 0 \leq dif ( s ) \leq θ \\ 1 - p , & - θ \leq dif ( s ) < 0 \\ 0 , & dif ( s ) < - θ\end{matrix} \\ AC ( s ) = α {f}_{R} ( s ) + ( 1 - α ) {f}_{I} ( s )$$

f_{R}(s) represents the centrality of the target entity, f_{I}(s) represents the uncertainty of the target entity, dif(s) represents the difference between the centrality and the uncertainty of the target entity, α and (1−α) respectively represent the centrality weight for the centrality of the target entity and the uncertainty weight for the uncertainty of the target entity, p represents a preset constant coefficient in an interval of [0,1], [−θ, θ] represents the preset range of the difference, AC(s) represents the weight distribution of the centrality and uncertainty of the target entity in each sample entity pair, i.e., the representative value of the target entity.

From the above formula, it can be seen that the terminal device can determine the centrality weight and uncertainty weight of the target entity based on the range of the difference between the centrality and uncertainty of the target entity, to determine the representative value of the target entity.

Furthermore, in the above formula, it can be seen that when the centrality of a target entity is significantly greater than the uncertainty of the target entity, when determining the representative value of the target entity, only the centrality of the target entity can be considered, without considering the uncertainty of the target entity. When the difference between the centrality of the target entity and the uncertainty of the target entity is within a preset deviation range, when determining the representative value of the target entity, both the centrality of the target entity and the uncertainty of the target entity should be considered. When the centrality of the target entity is significantly less than the uncertainty of the target entity, when determining the representative value of the target entity, only the uncertainty of the target entity can be considered, and the centrality of the target entity can be ignored.

In some embodiments, in early stages of the entity alignment model training process, a training gain value from the sample entity pair constructed based on the centrality of the target entity is much greater than a training gain value of the sample entity pair constructed based on the uncertainty of the target entity pair.

Therefore, in the present disclosure, the centrality weight for the centrality of the target entity and the uncertainty weight for the uncertainty of the target entity can be determined based on a number of a current training round of an entity alignment model, where the larger the number of the current training round, the smaller the centrality weight for the centrality of the target entity, and the greater the uncertainty weight for the uncertainty of the target entity.

That is, in the early stage of the entity alignment model training process, the terminal device can construct the sample entity pair independently based on the centrality of the target entity. The target entity with higher centrality in the first knowledge graph and the entity in the second knowledge graph corresponding to the target entity form the sample entity pair constructed based on the centrality of the target entity. In the above formula, the weight α of the centrality f_{R}(s) of the target entity in the representative value AC(s) of the target entity is 1, and the weight (1−α) of the uncertainty f_{I}(s) of the target entity is 0.

In the mid-term stage of the entity alignment model training process, although the entity alignment model has been trained for a certain degree, the overall entity alignment ability of the model is not stable, and the alignment accuracy is not high, making it difficult to meet the standard requirements. At this time, the training value of the centrality of the target entity and the training value of the uncertainty of the target entity are not significantly different for the current training process, both have a certain training gain for the entity alignment model training process, so a sample entity pair constructed based on both the centrality and uncertainty of the target entity will bring higher training benefits to the entity alignment model compared to constructing the sample entity pair independently based on the centrality or the uncertainty of the target entity. Therefore, in the mid-term stage of the entity alignment model training process, the terminal device can construct the sample entity pair based on both the centrality and uncertainty of the target entity.

In the above formula, when the centrality f_{R}(s) of the target entity is slightly greater than the uncertainty f_{I}(s) of the target entity, the weight α of the centrality f_{R}(s) of the target entity in the representative value AC(s) of the target entity is a preset value p, and the weight (1−α) of the uncertainty f_{I}(s) of the target entity is 1−p. When the uncertainty f_{I}(s) of the target entity is slightly greater than the centrality Δf_{R}(s) of the target entity, the weight (1−α) of the uncertainty f_{I}(s) of the target entity in the representative value AC(s) of the target entity is the preset value p, while the weight α of the centrality f_{R}(s) of the target entity is 1−p.

In the later stage of the entity alignment model training process, when the entity alignment model has a certain accuracy of entity alignment ability after many rounds of training, the sample entity pair constructed based on the uncertainty of the target entity will bring higher training value to the model training process compared to the sample entity pair constructed based on the centrality of the target entity. Training the entity alignment model using the target entity with high uncertainty can effectively improve the entity alignment ability of the entity alignment model, thereby obtaining an entity alignment model with high alignment accuracy. Therefore, in the later stage of the entity alignment model training process, the terminal device can construct the sample entity pair independently based on the uncertainty of the target entity. The target entity with higher uncertainty in the first knowledge graph and the entity in the second knowledge graph corresponding to the target entity form the sample entity pair constructed based on the uncertainty of the target entity. In the above formula, the weight α of the centrality f_{R}(s) of the target entity in the representative value AC(s) of the target entity is 0, and the weight (1−α) of the uncertainty f_{I}(s) of the target entity is 1.

In S105, a to-be-trained entity alignment model is trained based on each sample entity pair.

In the present disclosure, the terminal device can use each sample entity pair for the training process of the to-be-trained entity alignment model, and through training iterations, obtain an entity alignment model with entity alignment capability.

It should be noted that at the end of each training round, the terminal device recalculates the centrality weight and the uncertainty weight of each target entity based on the formula for constructing a sample entity pair, and then construct each sample entity pair for a new training round.

In S106, entity alignment is performed on to-be-aligned knowledge graphs according to the trained entity alignment model, to obtain a merged knowledge graph after the entity alignment; and a target task is executed based on the merged knowledge graph.

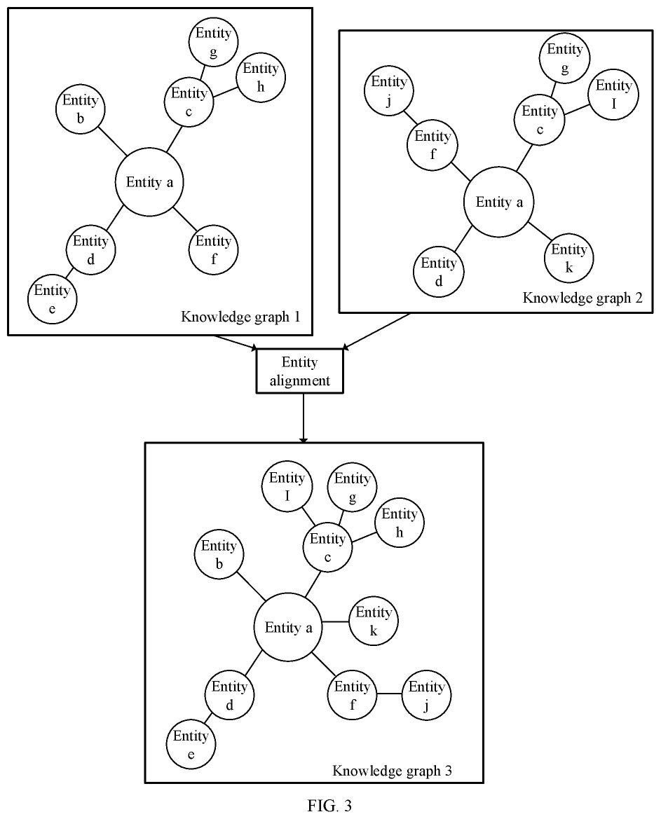

In the present disclosure, the terminal device uses a trained entity alignment model with entity alignment capability to perform entity alignment on knowledge graphs involved in the target task, and merges differential information of the same entity in different knowledge graphs, so that knowledge graphs can be merged into one knowledge graph with a wider coverage of entities. Then, the merged knowledge graph is used to execute the target task. To facilitate the explanation of the merging process of the entity alignment for knowledge graphs, the following will introduce a schematic diagram of merging knowledge graphs through entity alignment, as shown in FIG. 3.

FIG. 3 is a schematic diagram of merging knowledge graphs through entity alignment provided in the present disclosure.

In FIG. 3, entity a, entity c, entity d, and so on are common entities of knowledge graph 1 and knowledge graph 2, and entity b, entity h and so on are differential entities of knowledge graph 1 and knowledge graph 2. From FIG. 3, it can be seen that after entity alignment of knowledge graph 1 and knowledge graph 2, knowledge graph 3 is obtained, which includes all common entities of knowledge graph 1 and knowledge graph 2, and the differential entities between knowledge graph 1 and knowledge graph 2 are merged, and the coverage of the finally obtained knowledge graph 3 covers both knowledge graph 1 and knowledge graph 2.

From the above content, it can be seen that the method for task execution based on the knowledge graph obtained through entity alignment provided in the present disclosure can evaluate the target entities with a high training value in the training process of an entity alignment model based on the centrality and uncertainty of the target entity in the knowledge graph, and thus the target entity with a high training benefit is used in the training process of an entity alignment model, to obtain an entity alignment model with high alignment accuracy, to execute the target task. The method can not only obtain an entity alignment model with high alignment accuracy, but also greatly reduce the sample annotation cost during the training process, which improves the efficiency of the model training process, and also significantly improves the efficiency of the overall task execution.

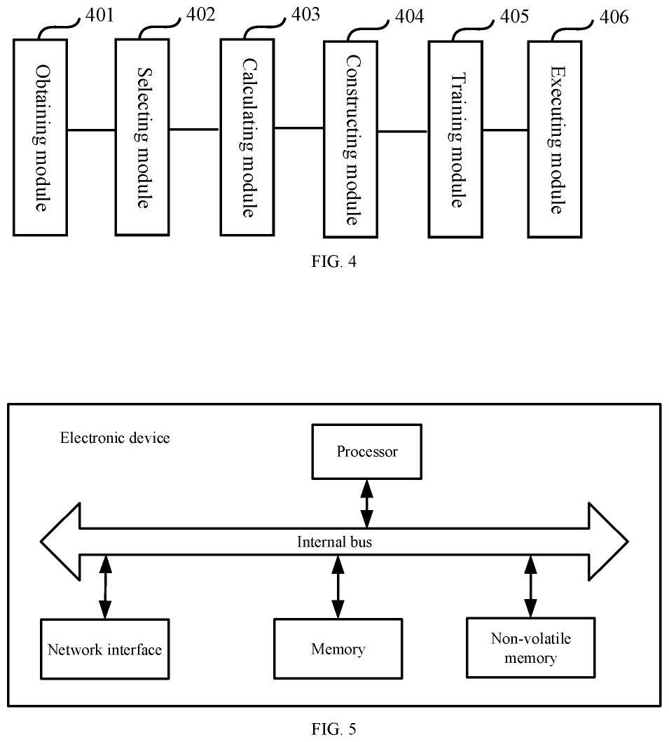

The above is methods of one or more embodiments of the present disclosure. Based on the same idea, the present disclosure further provides corresponding apparatuses for task execution based on the knowledge graph obtained through entity alignment, as shown in FIG. 4.

FIG. 4 is a schematic diagram of an apparatus for task execution based on a knowledge graph obtained through entity alignment provided in the present disclosure. The apparatus includes:
an obtaining module 401, configured to obtain a knowledge graph pair, which includes a first knowledge graph and a second knowledge graph;
a selecting module 402, configured to select a target entity from entities in the first knowledge graph;
a calculating module 403, configured to determine a centrality for the target entity based on the entity corresponding to the neighboring node of the target entity in the first knowledge graph in the preset adjacency range, and determine an uncertainty of the target entity based on alignment probabilities between at least some entities in the second knowledge graph and the target entity, and alignment probabilities between the entity corresponding to the neighboring node and at least some entities in the second knowledge graph;
a constructing module 404, configured to construct a sample entity pair based on the centrality and the uncertainty of the target entity;
a training module 405, configured to train a to-be-trained entity alignment model based on the sample entity pair; and
an executing module 406, configured to perform entity alignment on to-be-aligned knowledge graphs according to a trained entity alignment model, to obtain a merged knowledge graph after the entity alignment; and execute a target task based on the merged knowledge graph.

In some embodiments, the selecting module 402 is configured to determine an out-degree of each of the entities in the first knowledge graph based on connection relationships between the entities in the first knowledge graph; and filter the entities in the first knowledge graph based on the out-degree of each of the entities in the first knowledge graph, to obtain the target entity.

In some embodiments, the calculating module 403 is configured to determine a single centrality of the target entity based on an out-degree of the target entity; determine a single centrality of the entity corresponding to the neighboring node based on an out-degree of the entity corresponding to the neighboring node of the node corresponding to the target entity in the first knowledge graph within the preset adjacency range; and determine the centrality of the target entity based on the single centrality of the target entity and the single centrality of the entity corresponding to the neighboring node.

In some embodiments, the calculating module 403 is configured to determine the alignment probabilities between the target entity and the at least some entities in the second knowledge graph; determine a single uncertainty of the target entity based on the alignment probabilities between the target entity and the at least some entities in the second knowledge graph; determine the alignment probabilities between the entity corresponding to the neighboring node and the at least some entities in the second knowledge graph based on the entity corresponding to the neighboring node and the at least some entities in the second knowledge graph; determine a single uncertainty of the entity corresponding to the neighboring node based on the alignment probabilities between the entity corresponding to the neighboring node and the at least some entities in the second knowledge graph; and determine the uncertainty of the target entity based on the single uncertainty of the target entity and the single uncertainty of the entity corresponding to the neighboring node.

In some embodiments, the calculating module 403 is configured to determine a difference between the alignment probabilities between the target entity and the at least some entities in the second knowledge graph based on the alignment probabilities between the target entity and the at least some entities in the second knowledge graph; and determine the single uncertainty of the target entity based on the difference between the alignment probabilities between the target entity and the at least some entities in the second knowledge graph; and
the calculating module 403 is configured to determine a difference between the alignment probabilities between the entity corresponding to the neighboring node and the at least some entities in the second knowledge graph based on the alignment probabilities between the entity corresponding to the neighboring node and the at least some entities in the second knowledge graph; and determine the single uncertainty of the entity corresponding to the neighboring node based on the difference between the alignment probabilities between the entity corresponding to the neighboring node and the at least some entities in the second knowledge graph.

In some embodiments, the constructing module 404 is configured to determine a centrality weight for the centrality of the target entity, and an uncertainty weight for the uncertainty of the target entity; determine a representative value of the target entity based on the centrality of the target entity, the centrality weight, the uncertainty of the target entity, and the uncertainty weight; and filter the target entity based on the representative value of the target entity; and construct the sample entity pair based on a filtered target entity.

In some embodiments, the constructing module 404 is configured to determine the centrality weight for the centrality of the target entity, and the uncertainty weight for the uncertainty of the target entity based on a difference between the centrality and the uncertainty of the target entity.

In some embodiments, the constructing module 404 is configured to determine the centrality weight for the centrality of the target entity, and the uncertainty weight for the uncertainty of the target entity based on a number of a current training round of an entity alignment model, where the larger the number of the current training round, the smaller the centrality weight for the centrality of the target entity, and the greater the uncertainty weight for the uncertainty of the target entity.

The present disclosure further provides a computer-readable storage medium, where the storage medium stores a computer program, and the computer program is configured to achieve the method of task execution based on the knowledge graph obtained through entity alignment provided in FIG. 1 above.

The present disclosure further provides a schematic structural diagram of an electronic device corresponding to FIG. 1, as shown in FIG. 5. As shown in FIG. 5, at the hardware level, the electronic device includes a processor, an internal bus, a network interface, a memory, and a non-volatile memory, and may include hardware required for other operations. The processor reads the corresponding computer program from non-volatile memory into memory and runs the computer program to implement the method of task execution based on the knowledge graph obtained through entity alignment as described in FIG. 1 above.

In the 1990s, it was clear that improvements to a technology could be distinguished between hardware improvements (e.g., improvements to circuit structures such as diodes, transistors, switches, etc.) and software improvements (improvements to a method flow). However, with the development of technology, currently, the improvements of many method flows can be regarded as the direct improvements of the hardware circuit structures. Designers almost always get the corresponding hardware circuit structure by programming the improved method flow into the hardware circuit. Therefore, it cannot be said that a method flow improvement cannot be implemented with a hardware physical module. For example, a Programmable Logic Device (PLD) (e.g., Field Programmable Gate Array (FPGA)) is one such integrated circuit whose logic function is determined by user programming of the device. A digital system is “integrated” on a PLD by the designer's own programming, without the need for a chip manufacturer to design and manufacture a dedicated integrated circuit chip. Moreover, nowadays, instead of making IC chips manually, this programming is mostly implemented by “logic compiler” software, which is similar to the software compiler used for program development and writing, and the original code has to be written in a specific programming language before it is compiled. This is called Hardware Description Language (HDL), and there is not only one HDL, but many kinds, such as Advanced Boolean Expression Language (ABEL), Altera Hardware Description Language (AHDL), Confluence, Cornell University Programming Language (CUPL), HDCal, Java Hardware Description Language (JHDL), Lava, Lola, MyHDL, PALASM, Ruby Hardware Description Language (RHDL), etc. Currently, the most commonly used is Very-High-Speed Integrated Circuit Hardware Description Language (VHDL) and Verilog. It should also be clear to those skilled in the art that a hardware circuit implementing the logical method flow can be easily obtained by simply programming the method flow with a little logic in one of the above hardware description languages and programming the method flow into the integrated circuit.

The controller can be implemented in any suitable manner, for example, the controller can take the form of, for example, a microprocessor or processor and a computer readable medium storing computer readable program code (e.g., software or firmware) executable by the (micro) processor, logic gates, switches, Application Specific Integrated Circuit (ASIC), programmable logic controllers and embedded microcontrollers. Examples of the controllers may include, but are not limited to, the following microcontrollers: ARC 625D, Atmel AT91SAM, Microchip PIC18F26K20, and Silicone Labs C8051F320, and memory controllers may also be implemented as part of the control logic of the memory. It is also known to those skilled in the art that, in addition to implementing the controller in a purely computer readable program code manner, it is entirely possible to make the controller perform the same function in the form of logic gates, switches, specialized integrated circuits, programmable logic controllers, embedded microcontrollers, etc. by logically programming the method steps. Thus, such a controller can be considered as a hardware component, and the devices included therein for implementing various functions can also be considered as structures within the hardware component. Or even, the apparatus for implementing various functions can be considered as both a software module for implementing a method and a structure within a hardware component.

The systems, apparatuses, modules, or units elucidated in the above embodiments can be implemented specifically by a computer chip or entity, or by a product with certain functions. An exemplary implementation device is a computer. Specifically, the computer may be, for example, a personal computer, a laptop computer, a cellular phone, a camera phone, a smart phone, a personal digital assistant, a media player, a navigation device, an email device, a gaming console, a tablet computer, a wearable device, or a combination of any of these devices.

For the convenience of description, the above devices are divided into various units according to their functions and described respectively. It is, of course, possible to implement the functions of each unit in the same or multiple software and/or hardware when implementing the present disclosure.

It should be understood by those skilled in the art that embodiments of the present disclosure may be provided as methods, systems, or computer program products. Accordingly, the present disclosure may take the form of an entirely hardware embodiment, an entirely software embodiment, or an embodiment combining software and hardware aspects. Furthermore, the present disclosure may employ the form of a computer program product implemented on one or more computer-usable storage media (including, but not limited to, disk storage, CD-ROM, optical storage, etc.), where the one or more computer-usable storage media having computer-usable program code.
the present disclosure is described with reference to flowcharts and/or block diagrams of methods, devices (systems), and computer program products according to embodiments of the present disclosure. It is to be understood that each process and/or block in the flowchart and/or block diagram, and the combination of processes and/or blocks in the flowchart and/or block diagram, may be implemented by computer program instructions. These computer program instructions may be provided to a processor of a general-purpose computer, a specialized computer, an embedded processor, or other programmable data processing device to produce a machine such that instructions executed by the processor of the computer or other programmable data processing device produce a apparatus for implementing a function specified in one or more processes of the flowchart and/or one or more blocks of the block diagram.

These computer program instructions may also be stored in a computer-readable memory capable of directing the computer or other programmable data processing device to operate in a particular manner such that the instructions stored in the computer-readable memory produce an article of manufacture including an instruction apparatus that implements the function specified in one or more processes of the flowchart and/or one or more blocks of the block diagram.

These computer program instructions may also be loaded onto a computer or other programmable data processing device such that a series of operational steps are executed on the computer or other programmable device to produce computer-implemented processing such that the instructions executed on the computer or other programmable device provide the steps used to perform the functions specified in one or more processes of the flowchart and/or one or more blocks of the block diagram.

In an exemplary configuration, the computing device includes one or more processors (CPUs), input/output interfaces, network interfaces, and memory.

Memory may include at least one of non-permanent storage in computer readable media, random access memory (RAM) or non-volatile memory, such as read only memory (ROM) or flash RAM. Memory is an example of a computer readable medium.

Computer readable media include permanent and non-permanent, removable and non-removable media that can be implemented by any method or technology to store information. Information may be computer readable instructions, data structures, modules of a program, or other data. Examples of storage media for computers include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technologies, compact disc read only memory (CDROM), digital versatile disc (DVD) or other optical storage, magnetic cartridge tape, magnetic tape magnetic disk storage, other magnetic storage device or any other non-transport medium that can be used to store information that can be accessed by a computing device. As defined herein, computer readable media does not include transitory computer readable media, such as modulated data signals and carriers.

It should also be noted that the term “include”, “comprise” or any other variation thereof is intended to cover non-exclusive inclusion, such that a process, method, article, or device that includes a set of elements includes not only those elements, but also other elements that are not explicitly listed, or other elements that are inherent to such a process, method, commodity, or device. Without further limitation, the element defined by the statement “including a . . . ” do not preclude the existence of additional identical elements in the process, method, article, or device that include the element.

It should be understood by those skilled in the art that embodiments of the present disclosure may be provided as methods, systems, or computer program products. Accordingly, the present disclosure may take the form of an entirely hardware embodiment, an entirely software embodiment, or an embodiment combining software and hardware aspects. Furthermore, the present disclosure may employ the form of a computer program product implemented on one or more computer-usable storage media (including, but not limited to, disk storage, CD-ROM, optical storage, etc.), where the one or more computer-usable storage media having computer-usable program code.

The present disclosure may be described in the general context of computer-executable instructions executed by a computer, such as a program module. Generally, a program module includes routines, programs, objects, components, data structures, and the like that perform a specific task or implement a specific abstract data type. The present disclosure may also be practiced in distributed computing environments where tasks are performed by remote processing devices that are connected via a communication network. In distributed computing environments, program modules may be located in local and remote computer storage medium, including storage devices.

The various embodiments in the present disclosure are described in a progressive manner, and the same or similar parts between the various embodiments may be referred to each other, and each embodiment focuses on the differences from other embodiments. In particular, for a system embodiment, since it is basically similar to the method embodiment, the description is relatively simple, and for related parts, please refer to the partial description of the method embodiment.

The above description is only embodiments of the present disclosure and is not intended to limit the present disclosure. For those skilled in the art, various modifications and changes may be made in the present disclosure. Any modification, equivalent replacement, improvement, etc. present the spirit and principle of the present disclosure shall be included in the scope of the claims of the present disclosure.

1. A method for task execution based on a knowledge graph obtained through entity alignment, the method comprising:
obtaining a knowledge graph pair that comprises a first knowledge graph and a second knowledge graph;
selecting a target entity from entities in the first knowledge graph;
determining a centrality of the target entity based on an entity corresponding to a neighboring node of a node corresponding to the target entity in the first knowledge graph within a preset adjacency range;
determining an uncertainty of the target entity based on
alignment probabilities between one or more first entities in the second knowledge graph and the target entity, and
alignment probabilities between the entity corresponding to the neighboring node and one or more second entities in the second knowledge graph;
constructing a sample entity pair based on the centrality of the target entity and the uncertainty of the target entity;
training a to-be-trained entity alignment model based on the sample entity pair;
performing entity alignment on to-be-aligned knowledge graphs according to the trained entity alignment model, to obtain a merged knowledge graph after the entity alignment; and
executing a target task based on the merged knowledge graph.

2. The method according to claim 1, wherein selecting the target entity from the entities in the first knowledge graph comprises:
determining an out-degree of each of the entities in the first knowledge graph based on connection relationships between the entities in the first knowledge graph; and
filtering the entities in the first knowledge graph based on the out-degree of each of the entities in the first knowledge graph to obtain the target entity.

3. The method according to claim 2, wherein determining the centrality of the target entity based on the entity corresponding to the neighboring node of the node corresponding to the target entity in the first knowledge graph within the preset adjacency range comprises:
determining a single centrality of the target entity based on an out-degree of the target entity;
determining a single centrality of the entity corresponding to the neighboring node based on an out-degree of the entity corresponding to the neighboring node of the node corresponding to the target entity in the first knowledge graph within the preset adjacency range; and
determining the centrality of the target entity based on the single centrality of the target entity and the single centrality of the entity corresponding to the neighboring node.

4. The method according to claim 1, wherein determining the uncertainty of the target entity based on the alignment probabilities between the one or more first entities in the second knowledge graph and the target entity, and the alignment probabilities between the entity corresponding to the neighboring node and the one or more first entities in the second knowledge graph comprises:
determining the alignment probabilities between the target entity and the one or more first entities in the second knowledge graph;
determining a single uncertainty of the target entity based on the alignment probabilities between the target entity and the one or more first entities in the second knowledge graph;
determining the alignment probabilities between the entity corresponding to the neighboring node and the one or more second entities in the second knowledge graph based on the entity corresponding to the neighboring node and the one or more second entities in the second knowledge graph;
determining a single uncertainty of the entity corresponding to the neighboring node based on the alignment probabilities between the entity corresponding to the neighboring node and the one or more second entities in the second knowledge graph; and
determining the uncertainty of the target entity based on the single uncertainty of the target entity and the single uncertainty of the entity corresponding to the neighboring node.

5. The method according to claim 4, wherein determining the single uncertainty of the target entity based on the alignment probabilities between the target entity and the one or more first entities in the second knowledge graph comprises:
determining a difference between the alignment probabilities between the target entity and the one or more first entities in the second knowledge graph based on the alignment probabilities between the target entity and the one or more first entities in the second knowledge graph; and
determining the single uncertainty of the target entity based on the difference between the alignment probabilities between the target entity and the one or more first entities in the second knowledge graph; and
wherein determining the single uncertainty of the entity corresponding to the neighboring node based on the alignment probabilities between the entity corresponding to the neighboring node and the one or more second entities in the second knowledge graph comprises:
determining a difference between the alignment probabilities between the entity corresponding to the neighboring node and the one or more second entities in the second knowledge graph based on the alignment probabilities between the entity corresponding to the neighboring node and the one or more second entities in the second knowledge graph; and
determining the single uncertainty of the entity corresponding to the neighboring node based on the difference between the alignment probabilities between the entity corresponding to the neighboring node and the one or more second entities in the second knowledge graph.

6. The method according to claim 1, wherein constructing the sample entity pair based on the centrality of the target entity and the uncertainty of the target entity comprises:
determining a centrality weight for the centrality of the target entity, and an uncertainty weight for the uncertainty of the target entity;
determining a representative value of the target entity based on the centrality of the target entity, the centrality weight, the uncertainty of the target entity, and the uncertainty weight; and
filtering target entities based on representative values of the target entities to determine at least one target entity; and
constructing the sample entity pair based on a determined target entity.

7. The method according to claim 6, wherein determining the centrality weight for the centrality of the target entity, and the uncertainty weight for the uncertainty of the target entity comprises:
determining the centrality weight for the centrality of the target entity, and the uncertainty weight for the uncertainty of the target entity based on a difference between the centrality of the target entity and the uncertainty of the target entity.

8. The method according to claim 6, wherein determining the centrality weight for the centrality of the target entity, and the uncertainty weight for the uncertainty of the target entity comprises:
determining the centrality weight for the centrality of the target entity, and the uncertainty weight for the uncertainty of the target entity based on a number of a current training round of an entity alignment model, wherein the larger is the number of the current training round, the smaller is the centrality weight for the centrality of the target entity, and the greater is the uncertainty weight for the uncertainty of the target entity.

9.-10. (canceled)

11. The method according to claim 6, wherein constructing the sample entity pair based on the determined target entity comprises:
after determining the determined target entity from the first knowledge graph, determining an entity in the second knowledge graph corresponding to the determined target entity based on correspondence relationships between entities in the first knowledge graph and entities in the second knowledge graph; and
constructing the sample entity pair based on the determined target entity in the first knowledge graph and the determined entity in the second knowledge graph.

12. A non-transitory computer readable storage medium storing a computer program executable by at least one processor to perform operations comprising:
obtaining a knowledge graph pair that comprises a first knowledge graph and a second knowledge graph;
selecting a target entity from entities in the first knowledge graph;
determining a centrality of the target entity based on an entity corresponding to a neighboring node of a node corresponding to the target entity in the first knowledge graph within a preset adjacency range;
determining an uncertainty of the target entity based on
alignment probabilities between one or more first entities in the second knowledge graph and the target entity, and
alignment probabilities between the entity corresponding to the neighboring node and one or more second entities in the second knowledge graph;
constructing a sample entity pair based on the centrality of the target entity and the uncertainty of the target entity;
training a to-be-trained entity alignment model based on the sample entity pair;
performing entity alignment on to-be-aligned knowledge graphs according to the trained entity alignment model, to obtain a merged knowledge graph after the entity alignment; and
executing a target task based on the merged knowledge graph.

13. The non-transitory computer readable storage medium according to claim 12, wherein selecting the target entity from the entities in the first knowledge graph comprises:
determining an out-degree of each of the entities in the first knowledge graph based on connection relationships between the entities in the first knowledge graph; and
filtering the entities in the first knowledge graph based on the out-degree of each of the entities in the first knowledge graph to obtain the target entity.

14. The non-transitory computer readable storage medium according to claim 13, wherein determining the centrality of the target entity based on the entity corresponding to the neighboring node of the node corresponding to the target entity in the first knowledge graph within the preset adjacency range comprises:
determining a single centrality of the target entity based on an out-degree of the target entity;
determining a single centrality of the entity corresponding to the neighboring node based on an out-degree of the entity corresponding to the neighboring node of the node corresponding to the target entity in the first knowledge graph within the preset adjacency range; and
determining the centrality of the target entity based on the single centrality of the target entity and the single centrality of the entity corresponding to the neighboring node.

15. The non-transitory computer readable storage medium according to claim 12, wherein determining the uncertainty of the target entity based on the alignment probabilities between the one or more first entities in the second knowledge graph and the target entity, and the alignment probabilities between the entity corresponding to the neighboring node and the one or more second entities in the second knowledge graph comprises:
determining the alignment probabilities between the target entity and the one or more first entities in the second knowledge graph;
determining a single uncertainty of the target entity based on the alignment probabilities between the target entity and the one or more first entities in the second knowledge graph;
determining the alignment probabilities between the entity corresponding to the neighboring node and the one or more second entities in the second knowledge graph based on the entity corresponding to the neighboring node and the one or more second entities in the second knowledge graph;
determining a single uncertainty of the entity corresponding to the neighboring node based on the alignment probabilities between the entity corresponding to the neighboring node and the one or more second entities in the second knowledge graph; and
determining the uncertainty of the target entity based on the single uncertainty of the target entity and the single uncertainty of the entity corresponding to the neighboring node.

16. The non-transitory computer readable storage medium according to claim 15, wherein determining the single uncertainty of the target entity based on the alignment probabilities between the target entity and the one or more first entities in the second knowledge graph comprises:
determining a difference between the alignment probabilities between the target entity and the one or more first entities in the second knowledge graph based on the alignment probabilities between the target entity and the one or more first entities in the second knowledge graph; and
determining the single uncertainty of the target entity based on the difference between the alignment probabilities between the target entity and the one or more first entities in the second knowledge graph; and
wherein determining the single uncertainty of the entity corresponding to the neighboring node based on the alignment probabilities between the entity corresponding to the neighboring node and the one or more second entities in the second knowledge graph comprises:
determining a difference between the alignment probabilities between the entity corresponding to the neighboring node and the one or more second entities in the second knowledge graph based on the alignment probabilities between the entity corresponding to the neighboring node and the one or more second entities in the second knowledge graph; and
determining the single uncertainty of the entity corresponding to the neighboring node based on the difference between the alignment probabilities between the entity corresponding to the neighboring node and the one or more second entities in the second knowledge graph.

17. The non-transitory computer readable storage medium according to claim 12, wherein constructing the sample entity pair based on the centrality and the uncertainty of the target entity comprises:
determining a centrality weight for the centrality of the target entity, and an uncertainty weight for the uncertainty of the target entity;
determining a representative value of the target entity based on the centrality of the target entity, the centrality weight, the uncertainty of the target entity, and the uncertainty weight; and
filtering target entities based on representative values of the target entities to determine at least one target entity; and
constructing the sample entity pair based on a determined target entity.

18. An electronic device, comprising:
at least one processor; and
at least one memory storing a computer program executable by the at least one processor to perform operations comprising:
obtaining a knowledge graph pair that comprises a first knowledge graph and a second knowledge graph;
selecting a target entity from entities in the first knowledge graph;
determining a centrality of the target entity based on an entity corresponding to a neighboring node of a node corresponding to the target entity in the first knowledge graph within a preset adjacency range;
determining an uncertainty of the target entity based on
alignment probabilities between one or more first entities in the second knowledge graph and the target entity, and
alignment probabilities between the entity corresponding to the neighboring node and one or more second entities in the second knowledge graph;
constructing a sample entity pair based on the centrality of the target entity and the uncertainty of the target entity;
training a to-be-trained entity alignment model based on the sample entity pair;
performing entity alignment on to-be-aligned knowledge graphs according to the trained entity alignment model, to obtain a merged knowledge graph after the entity alignment; and
executing a target task based on the merged knowledge graph.

19. The electronic device according to claim 18, wherein selecting the target entity from the entities in the first knowledge graph comprises:
determining an out-degree of each of the entities in the first knowledge graph based on connection relationships between the entities in the first knowledge graph; and
filtering the entities in the first knowledge graph based on the out-degree of each of the entities in the first knowledge graph to obtain the target entity,
wherein determining the centrality of the target entity based on the entity corresponding to the neighboring node of the node corresponding to the target entity in the first knowledge graph within the preset adjacency range comprises:
determining a single centrality of the target entity based on an out-degree of the target entity;
determining a single centrality of the entity corresponding to the neighboring node based on an out-degree of the entity corresponding to the neighboring node of the node corresponding to the target entity in the first knowledge graph within the preset adjacency range; and
determining the centrality of the target entity based on the single centrality of the target entity and the single centrality of the entity corresponding to the neighboring node.

20. The electronic device according to claim 18, wherein determining the uncertainty of the target entity based on the alignment probabilities between the one or more first entities in the second knowledge graph and the target entity, and the alignment probabilities between the entity corresponding to the neighboring node and the one or more second entities in the second knowledge graph comprises:
determining the alignment probabilities between the target entity and the one or more first entities in the second knowledge graph;
determining a single uncertainty of the target entity based on the alignment probabilities between the target entity and the one or more first entities in the second knowledge graph;
determining the alignment probabilities between the entity corresponding to the neighboring node and the one or more second entities in the second knowledge graph based on the entity corresponding to the neighboring node and the one or more second entities in the second knowledge graph;
determining a single uncertainty of the entity corresponding to the neighboring node based on the alignment probabilities between the entity corresponding to the neighboring node and the one or more second entities in the second knowledge graph; and
determining the uncertainty of the target entity based on the single uncertainty of the target entity and the single uncertainty of the entity corresponding to the neighboring node.

21. The electronic device according to claim 20, wherein determining the single uncertainty of the target entity based on the alignment probabilities between the target entity and the one or more first entities in the second knowledge graph comprises:
determining a difference between the alignment probabilities between the target entity and the one or more first entities in the second knowledge graph based on the alignment probabilities between the target entity and the one or more first entities in the second knowledge graph; and
determining the single uncertainty of the target entity based on the difference between the alignment probabilities between the target entity and the one or more first entities in the second knowledge graph; and
wherein determining the single uncertainty of the entity corresponding to the neighboring node based on the alignment probabilities between the entity corresponding to the neighboring node and the one or more second entities in the second knowledge graph comprises:
determining a difference between the alignment probabilities between the entity corresponding to the neighboring node and the one or more second entities in the second knowledge graph based on the alignment probabilities between the entity corresponding to the neighboring node and the one or more second entities in the second knowledge graph; and
determining the single uncertainty of the entity corresponding to the neighboring node based on the difference between the alignment probabilities between the entity corresponding to the neighboring node and the one or more second entities in the second knowledge graph.

22. The electronic device according to claim 18, wherein constructing the sample entity pair based on the centrality and the uncertainty of the target entity comprises:
determining a centrality weight for the centrality of the target entity, and an uncertainty weight for the uncertainty of the target entity;
determining a representative value of the target entity based on the centrality of the target entity, the centrality weight, the uncertainty of the target entity, and the uncertainty weight; and
filtering target entities based on representative values of the target entities to determine at least one target entity; and
constructing the sample entity pair based on a determined target entity.
